(19) United States
(12) Patent Application Publication
(10) Pub. No.: US 2004/0024647 A1
(43) Pub. Date: Feb. 5, 2004

(54) Courtesy customer callback feature

(75) Inventor: Edward Cheung, Richmond Hill (CA)

Correspondence Address: James G. Porcelli, WEBB ZIESENHEIM LOGSDON ORKIN & HANSON, P.C., 700 Koppers Building, 436 Seventh Avenue, Pittsburgh, PA, 15219-1818, US

(73) Assignee: Innings Telecom Inc., Markham (CA)

(21) Appl. No.: 10/209,179

(22) Filed: Jul. 31, 2002

(51) Int. Cl. G06F 17/60

(52) U.S. Cl. 705/26

(57) ABSTRACT

A system for notifying a customer of an event comprises a telephone system for receiving a call from the customer, a point of sale computer terminal for recording a customer order and a customer telephone number obtained from the call; and an application processor in communication with the point of sale computer terminal, the application processor is operative to (a) receive a command including the customer telephone number from the point of sale computer terminal and (b) call the customer in response to the command and play a pre-recorded message. The command corresponds to the customer order being cleared from the point of sale computer terminal.

### FIELD OF THE INVENTION

The present invention relates to a courtesy callback feature, in particular, a callback feature that automatically notifies a customer of the occurrence of an event.

### BACKGROUND OF THE INVENTION

In the field of fast food delivery, it is desirable to deliver a fresh product quickly in order to ensure customer satisfaction. In order to process a food order correctly and efficiently, a customer representative typically takes a customer order over the phone and informs the customer of the estimated delivery time. The estimated delivery time is based on the preparation time required, the number of orders waiting to be prepared and the distance that the order must delivered.

If the order has not arrived within the estimated time period, the customer often calls the food delivery establishment in order to check on the status of the order. Placing the call is bothersome for the customer and answering the call is time consuming for the customer service representative because the order must be tracked and then the information must be relayed to the customer.

It is therefore an object of the present invention to provide a courtesy customer callback feature to obviate or mitigate at least one of the above disadvantages.

### SUMMARY OF THE INVENTION

According to one aspect of the present invention there is provided a method for notifying a customer of an event using a telecommunications system, the method comprising:

receiving a call from the customer a point of sale computer terminal;

entering a customer telephone number associated with the customer into the point of sale computer terminal;

obtaining a customer order and entering the customer order into the point of sale computer terminal;

filling the customer order;

clearing the customer order from the point of sale computer terminal; and

automatically calling the customer and playing a message regarding the customer order.

According to another aspect of the present invention there is provided a system for notifying a customer of an event comprising:

a telephone system for receiving a call from the customer;

a point of sale computer terminal for recording a customer order and a customer telephone number obtained from the call; and

an application processor in communication with the point of sale computer terminal, the application processor operative to

(a) receive a command including the customer telephone number from the point of sale computer terminal;

(b) call the customer in response to the command and play a prerecorded message,

wherein the command corresponds to the customer order being cleared from the point of sale computer terminal.

According to yet another aspect of the present invention there is provided a system for notifying a customer of an event comprising:

a point of sale processor for receiving a call from the customer and a calling line identifier associated with the call; the point of sale processor operative to

(a) record the calling line identifier,

(b) record a customer order obtained from the call,

(c) automatically call the customer and play a pre-recorded message upon completion of the customer order,

wherein clearing the customer order form the point of sale processor prompts the point of sale processor to call the customer.

It is an advantage of an aspect of the present invention that a customer is informed of the progress of a food delivery order without placing a call to the store to inquire about the order.

### BRIEF DESCRIPTION OF THE DRAWINGS

Embodiments of the present invention will now be described more fully with reference to the accompanying drawings in which:

FIG. 1 is a schematic diagram generally showing a courtesy customer callback system of the present invention;

FIG. 2 is a schematic flow diagram showing the general operation of a first embodiment of the courtesy customer callback system;

FIG. 3 is a flow chart showing the operation of the embodiment of FIG. 2; and

FIG. 4 is a flow chart showing the operation of a second embodiment of the present invention.

### DETAILED DESCRIPTION OF THE PREFERRED EMBODIMENT

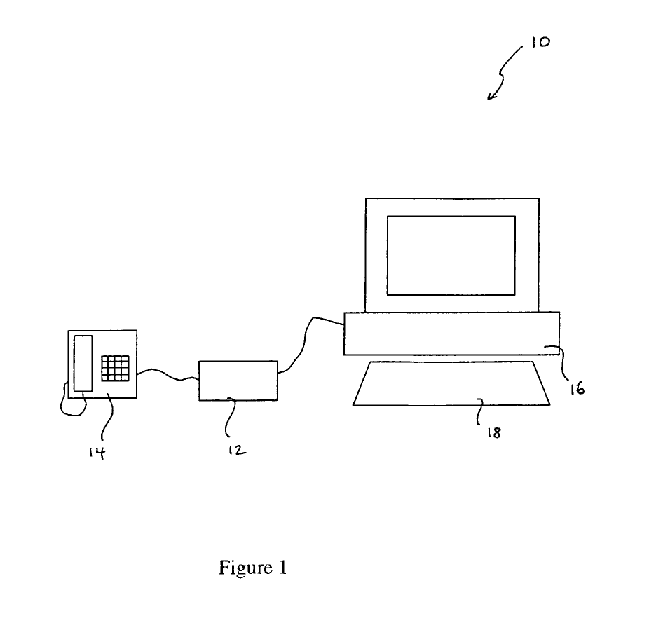

Referring now to FIG. 1, a courtesy customer callback system is generally shown at 10. The courtesy customer callback system 10 includes a CallWorks unit 12, which is in communication with a telephone system 14 and a point of sale computer terminal 16. The telephone system 14 is linked to a telecommunications system, having a telecommunications network supplier (not shown) to receive customer calls.

The CallWorks unit 12 is connected between the telecommunications network supplier and the telephone system 14. Communication with the telecommunications network supplier allows the CallWorks unit 12 to provide computer telephony database look up based on services available from the telecommunications network supplier. The look up services include Calling Line Identification (CLID) for providing the telephone number of the caller, Direct Inward Dialing (DID) for allowing an outside caller to directly dial an extension within a business without being processed by an operator or auto-attendant, and Dialed Number Identification Service (DNIS) for providing the telephone number that a caller dialed.

The CallWorks unit 12 follows standard analog telephony “Tip & Ring” and Dual Tone Multi Frequency (DTMF), or touch tone, protocol. These terms are well known in the art of telephone systems and therefore will not be explained herein.

Three groups of electronic circuit boards are mounted inside the CallWorks unit 12. The CallWorks unit 12 is an embedded system in which the software is burnt into the semiconductor memory. The motherboard is the main circuit board where system processors, memory and digital control circuits are located. Central-office-trunk and line interface electronic circuits are assembled on a second, preferably 3 inch by 8 inch, circuit board. There may be up to six Central-office-trunk and line interface cards plugged into edge connectors on the motherboard. There is a separate power supply module that delivers the required voltages to operate the system. The software of the CallWorks unit 12 runs in a multitasked environment. The kernel provides a pre-emptive priority-based scheduler to ensure the CPU is allocated to the highest priority task.

The CallWorks unit 12 further includes built-in serial connections to a local area network (LAN), modem, printer, Personal Computer (PC), wallboard, wall-mount display and desktop display.

In a preferred embodiment, the CallWorks unit 12 includes a built-in back lit Liquid Crystal Display (LCD) and membrane keypad. The membrane keypad is usable for system programming. Alternatively, an external computer may be used to program the system.

It will be appreciated by a person skilled in the art that the CallWorks unit 12 can be expanded by inserting additional line cards for connecting to the telecommunications network supplier. In addition, the CallWorks unit 12 may be provided with a voice messaging system.

The CallWorks unit 12 is shown as a separate unit, however, it is possible to incorporate the CallWorks unit 12 into the point of sale computer terminal 16. Further, it is possible to integrate the telephone system 14, the CallWorks unit 12 and the point of sale computer terminal 16 into a single unit having a point of sale processor.

The point of sale computer terminal 16 is provided with a keyboard 18 to allow a customer order to be entered into the computer terminal 16. Alternatively, the customer order may be entered into the point of sale computer terminal 16 using a mouse to select options from pull down menus.

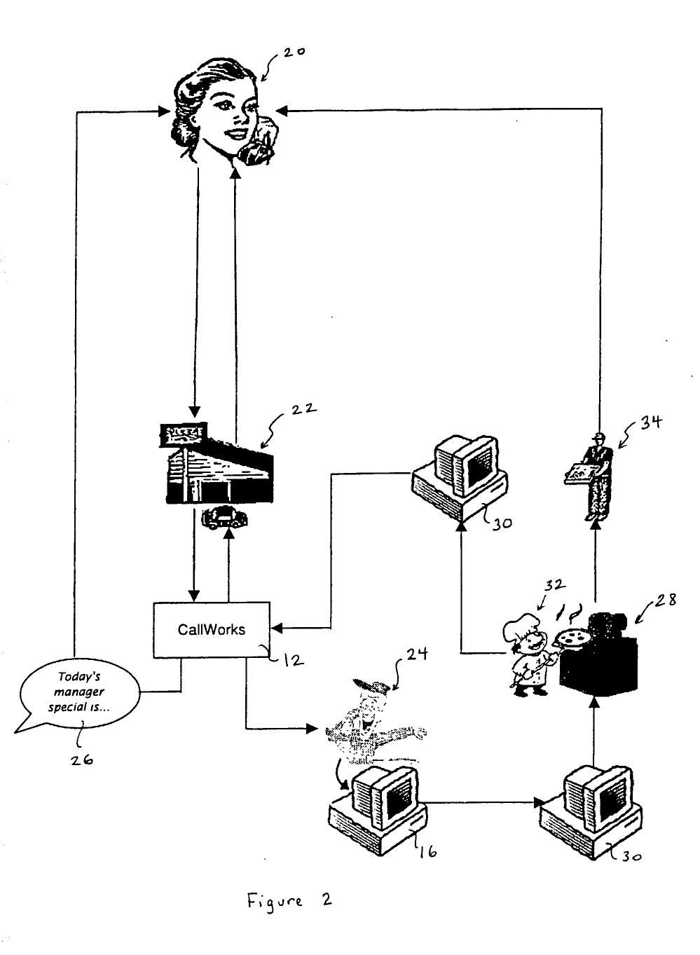

Referring to FIG. 2, a first embodiment of the courtesy customer callback system 10 is generally illustrated. As shown, the courtesy customer callback system 10 is employed in a pizza delivery store. A customer 20 telephones a pizza delivery store 22 from a personal telephone, such as a home telephone, a work telephone or a cell phone, for example. The call is immediately directed to the CallWorks unit 12. In this embodiment, the CallWorks unit 12 does not utilize the CLID, DID and DNIS services of the telecommunications network supplier. The CallWorks unit 12 answers the call and plays a promotional message 26 to the customer 20. The promotional message 26 typically contains information regarding special offers available from the pizza store 22, such as a “Manager's Special”.

The call is then forwarded from the CallWorks unit 12 to the telephone system 14 and a customer service representative 24 receives the call. The customer service representative takes the customer order and enters the order into the point of sale computer terminal 16. The customer service representative 24 further obtains the telephone number of the customer 20 and enters it into the point of sale computer terminal 16.

The cook 32 in the kitchen 28 receives the customer order from a display screen on a second computer terminal 30, which is linked to the point of sale computer terminal 16, and prepares the order. Once the order has been prepared and is ready for delivery, the cook clears the order by entering a command into the second computer terminal 30. In a preferred embodiment, the command is pressing a single key on a keyboard associated with the second computer terminal 30. Alternatively, the command may be executed by pressing a series of keys or by selecting a clear icon on the display screen using a mouse, for example. The prepared pizza is then taken by a delivery person 34 and delivered to the customer 20.

Clearing the customer order from the point of sale computer terminal 16 prompts the CallWorks unit 12 to telephone the customer 20 and play a prerecorded message. The pre-recorded message typically indicates that the order has been prepared and is on its way to the customer 20. After a customer 20 answers the call, for example with “Hello”, the CallWorks unit 12 waits for a brief moment before playing the pre-recorded message.

The pre-recorded message may be selected from any number of prerecorded messages. In order to specify which message is to be played to a customer 20, the customer service representative 24 enters the number of the selected prerecorded message into the point of sale computer terminal 16 at the time the order is placed. Alternatively, the number of a selected pre-recorded message is entered at the time the order is cleared from the point of sale computer terminal 16. Examples of pre-recorded messages include estimating a delivery time based on the time of day or weather conditions, informing the customer 20 that a special offer has been included with their order and reminding the customer 20 of the cost of their order and their chosen payment method.

Although a second computer terminal 30 is shown in the first embodiment, it will be appreciated that a single point of sale computer terminal 16 may be used. In such an arrangement, the cook 32 and the customer service representative 24 interact with the same computer terminal 16.

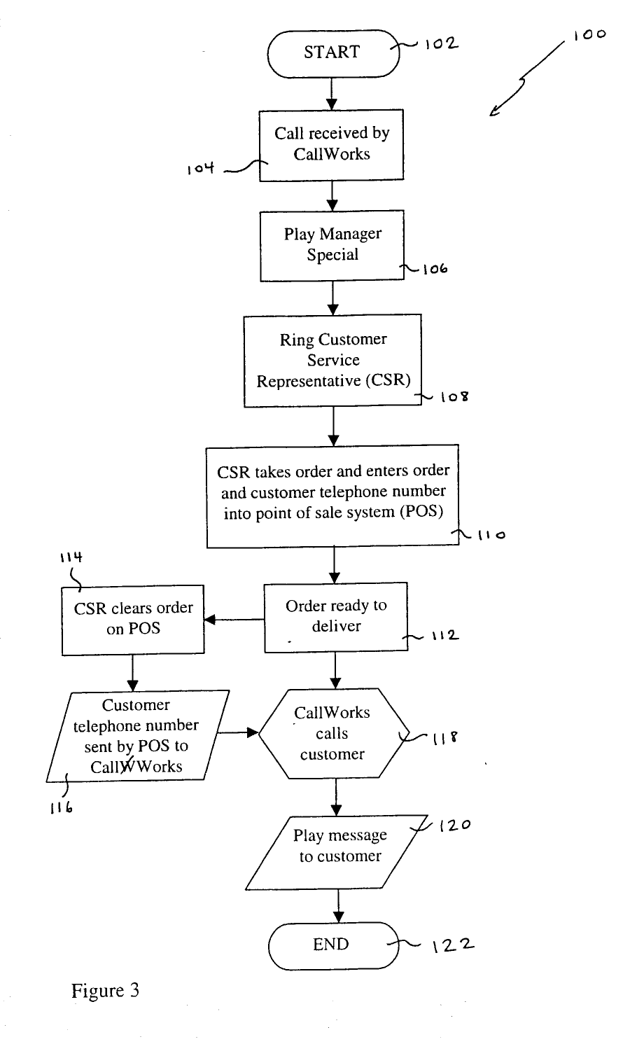

Referring to FIG. 3, the general operation of the first embodiment of the courtesy customer callback system 10 is illustrated at 100.

The courtesy customer callback system 10 is engaged at step 102 when the customer 20 telephones the pizza delivery store 22. The call is answered by the Callworks unit 12 at step 104 and the Manager's special promotional message 26 is played to the customer 20 at step 106. The call is then forwarded to the customer service representative 24, and the customer service representative 24 takes the customer order and the customer telephone number and enters both into the point of sale computer terminal 16, as indicated at steps 108 and 110. Once the order is ready for delivery at step 112, the customer service representative 24 clears the order from the point of sale computer terminal 16, as indicated at step 114. This prompts the point of sale computer terminal 16 to send the customer telephone number to the CallWorks unit 12, as indicated at step 116. The CallWorks unit 12 then calls the customer 20 and plays the pre-recorded message, as indicated at steps 118 and 120. The call is terminated by the customer 20 hanging up or, alternatively, by the message playing to completion, as indicated at 122.

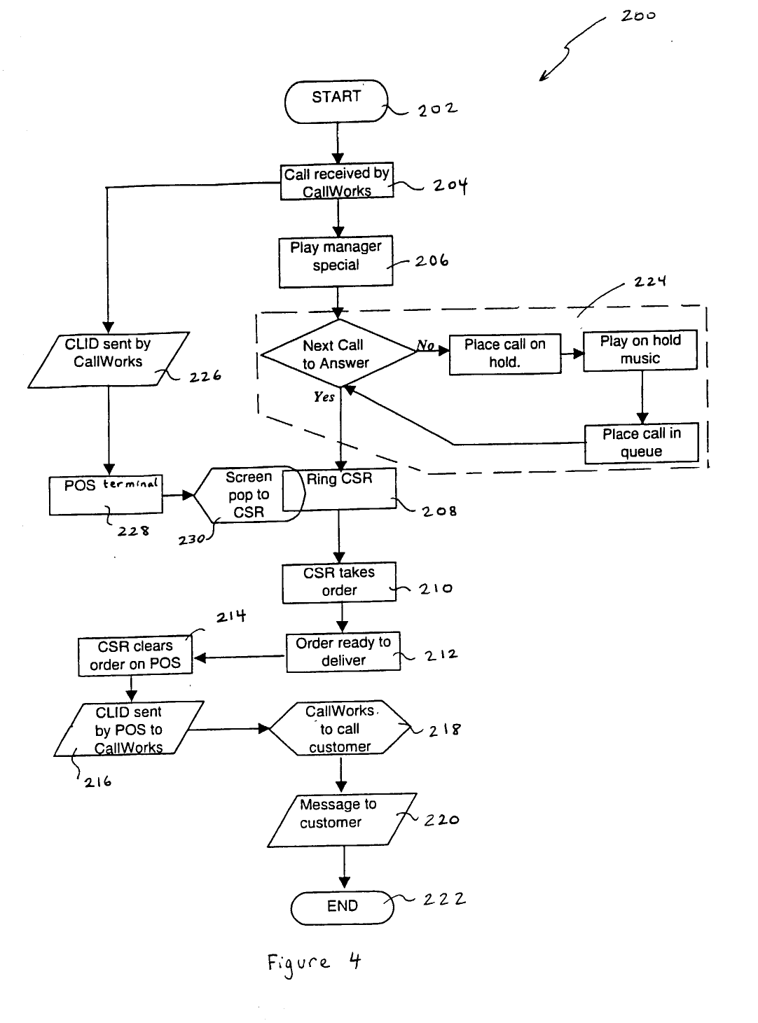

Referring to FIG. 4, the general operation of a second embodiment of the courtesy customer callback system 10 is illustrated at 200. In this embodiment, the customer telephone number is automatically input into the courtesy customer callback system 10 using the CLID service provided by the telecommunications network supplier. Obtaining a caller identification number from a telecommunications network supplier is well known in the art and therefore will not be described.

The second embodiment of the courtesy customer callback system 10 is engaged at step 202 when the customer 20 telephones the pizza delivery store 22. The call is answered by the Callworks unit 12 at step 204 and the CLID is sent from the CallWorks unit 12 to the point of sale computer terminal 16, as indicated at steps 226 and 228. When the call is initially answered by the CallWorks unit 12, the Manager's special promotional message 26 is played to the customer 20 at step 206. A busy loop 224 is provided to allow for multiple customer calls to be held while the customer service representative 24 is busy. Once the line becomes available, the call is forwarded to the customer service representative 24 at step 208. The point of sale computer terminal 16 displays the CLID information on the screen when the call is received by the customer service representative 24, as indicated by step 230. The customer service representative 24 obtains the customer order and enters the information into the point of sale computer terminal 16, as indicated at step 210. Once the order is ready for delivery at step 212, the customer service representative 24 clears the order from the point of sale computer terminal 16, as indicated at step 214. Clearing the order prompts the point of sale computer terminal 16 to send the CLID to the CallWorks unit 12, as indicated at step 216. The CallWorks unit 12 then calls the customer 20 and plays the pre-recorded message, as indicated at steps 218 and 220. The call is terminated by the customer 20 hanging up or, alternatively, by the message playing to completion, as indicated at 222.

The CallWorks unit 12 may be provided with a number of options including a delay option. The delay option automatically disconnects a call to a customer 20 after a predetermined number of rings if the call is not answered. It may also be programmed to automatically disconnect if the call is answered by an answering machine, or specifically, if silence is not detected after the call has been answered. CallWorks 12 can also be programmed to retry calling customers based on retry parameters, which include the number of retry attempts and the retry period.

It will be appreciated that the step 106, 206 of playing the manager's special promotional message to a customer 20 is optional and therefore, may be left out if so desired. The busy loop 224 is also optional.

It will be appreciated by a person skilled in the art that the courtesy customer callback system 10 is not limited to operating in a fast food delivery environment. The system 10 can be employed in various industries to notify customers of an event. For example, the system 10 may be used in the medical or dental fields to inform patients of upcoming scheduled appointments or, alternatively, to inform patient's of the need to schedule appointments. In addition, credit card companies could use the system 10 to confirm the receipt of a bill payment.

Although preferred embodiments of the present invention have been described, those of skill in the art will appreciate that variations and modifications may be made without departing from the spirit and scope thereof as defined by the appended claims.

We claim:

1. A method for notifying a customer of an event using a telecommunications system, said method comprising:
receiving a call from said customer at a point of sale computer terminal;
entering a customer telephone number associated with said customer into said point of sale computer terminal;
obtaining a customer order and entering said customer order into said point of sale computer terminal;
filling said customer order;
clearing said customer order from said point of sale computer terminal; and
automatically calling said customer and playing a message regarding said customer order.

2. A method as claimed in claim 1, wherein said customer telephone number is a calling line identification that is forwarded from a telecommunications network supplier to said point of sale computer terminal.

3. A method as claimed in claim 1, wherein said customer order is for a food delivery item.

4. A method as claimed in claim 3, wherein said food delivery item is a pizza.

5. A system for notifying a customer of an event comprising:
a telephone system for receiving a call from said customer;
a point of sale computer terminal for recording a customer order and a customer telephone number obtained from said call; and
an application processor in communication with said point of sale computer terminal, said application processor operative to
(a) receive a command including said customer telephone number from said point of sale computer terminal;
(b) call said customer in response to said command and play a prerecorded message,
wherein said command corresponds to said customer order being cleared from said point of sale computer terminal.

6. A method as claimed in claim 5, wherein said customer telephone number is a calling line identification that is forwarded from a telecommunications network supplier to said point of sale computer terminal.

7. A system for notifying a customer of an event comprising:
a point of sale processor for receiving a call from said customer and a calling line identifier associated with said call; said point of sale processor operative to
(a) record said calling line identifier,
(b) record a customer order obtained from said call,
(c) automatically call said customer and play a pre-recorded message upon completion of said customer order,
wherein clearing said customer order form said point of sale processor prompts said point of sale processor to call said customer.
